(19) United States
(12) Patent Application Publication
(10) Pub. No.: US 2024/0026194 A1
(43) Pub. Date: Jan. 25, 2024

(54) ENHANCED STYRENE-ETHYLENE-BUTYLENE-STYRENE (SEBS) / THERMOPLASTIC POLYURETHANE (TPU) BLEND FOR CONTINUOUS BONDING OPERATIONS

(71) Applicant: BIXBY INTERNATIONAL CORPORATION, NEWBURYPORT, MA (US)

(72) Inventor: Ethel BERMEJO, Somerville, MA (US)

(73) Assignee: BIXBY INTERNATIONAL CORPORATION, NEWBURYPORT, MA (US)

(21) Appl. No.: 18/355,274

(22) Filed: Jul. 19, 2023

Related U.S. Application Data
(60) Provisional application No. 63/390,807, filed on Jul. 20, 2022.

(51) Int. Cl. C09J 153/00

(52) U.S. Cl. CPC C09J 153/005; C09J 2301/312; C09J 2301/304

(57) ABSTRACT

An automatic continuous bonding system includes a first roller for controlling a speed and a tension of an adhesive tape, the adhesive tape comprising a styrene-ethylene-butylene-styrene (SEBS) block copolymer blended with 5% to 20% by weight of an aromatic polyester thermoplastic polyurethane (TPU), a second roller for a speed and a tension of a fabric, and a heated air nozzle, the heated air nozzle generating heated air to melt the adhesive tape to the fabric passing between the first and second rollers.

### CROSS REFERENCE TO RELATED APPLICATIONS

This application claims benefit from U.S. Provisional Patent Application Ser. No. 63/390,807, filed Jul. 20, 2022, which is incorporated by reference in its entirety.

### STATEMENT REGARDING GOVERNMENT INTEREST

Not applicable.

### BACKGROUND OF THE INVENTION

The present invention generally relates to polymeric materials, and in particular, to enhanced styrene-ethylene-butylene-styrene (SEBS)/thermoplastic polyurethane (TPU) blend for continuous bonding operations.

In general, styrene-ethylene-butylene-styrene, also known as SEBS, is an important thermoplastic elastomer (TPE) that behaves like rubber without undergoing vulcanization. SEBS is strong and flexible, has excellent heat and UV resistance and is easy to process. It is produced by partial and selective hydrogenating of styrene-butadiene-styrene copolymer (SBS) which improves the thermal stability, weathering and oil resistance, and makes SEBS steam sterilizable. However, hydrogenation also reduces the mechanical performance and increases the cost of the polymer. SEBS elastomers are often blended with other polymers to enhance their performance.

Thermoplastic polyurethane (TPU) is a thermoplastic elastomer block copolymer that consists of alternating soft and hard segments or domains formed by the reaction of three building blocks: the polyol, the diisocyanate and the chain extender or short chain diols. TPU material is tough, flexible, durable and resistant to abrasions like oils and lubricants. The unique blend of the three building blocks makes it suitable for various applications in automotive, sports, and textile coatings, breathable films, and so forth.

TPU thermoplastic provides great load-bearing capacity, high elongation at break, and fantastic tensile strength. The blended material can be utilized as soft engineering plastic and soft rubber—the different ranges of inbuilt hardness (Shore 30A-Shore 100A). TPU material is also used as a premium additive for other thermoplastics like polycarbonate and ABS to improve their toughness and elongation.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In an aspect, the invention features an adhesive material composition including a styrene-ethylene-butylene-styrene (SEBS) block copolymer blended with 5% to 20% by weight of an aromatic polyester thermoplastic polyurethane (TPU).

In another aspect, the invention features automatic continuous bonding system including a first roller for controlling a speed and a tension of an adhesive tape, the adhesive tape comprising a styrene-ethylene-butylene-styrene (SEBS) block copolymer blended with 5% to 20% by weight of an aromatic polyester thermoplastic polyurethane (TPU), a second roller for a speed and a tension of a fabric, and a heated air nozzle, the heated air nozzle generating heated air to melt the adhesive tape to the fabric passing between the first and second rollers.

In still another aspect, the invention features an adhesive material composition including a styrene-ethylene-butylene-styrene (SEBS) block copolymer blended with 5% to 20% by weight of an aromatic polyether thermoplastic urethane.

In yet another aspect, the invention features an automatic continuous bonding system including a first roller for controlling a speed and a tension of an adhesive tape, the adhesive tape comprising a styrene-ethylene-butylene-styrene (SEBS) block copolymer blended with 5% to 20% by weight of an aromatic polyether thermoplastic polyurethane, a second roller for a speed and a tension of a fabric, and a heated air nozzle, the heated air nozzle generating heated air to melt the adhesive tape to the fabric passing between the first and second rollers.

Embodiments of the invention may have one or more of the following advantages.

The present invention requires long-term durability under high-elongation with resiliency.

The present invention cannot be a pressure-sensitive adhesive as it depends on having the elastic resiliency of a solid at high elongation.

The present invention does not depend on polyolefins and cannot utilize tackifiers.

The present invention utilizes traditional SEBS with traditional TPU to lower activation temps while maintaining elasticity, resiliency, in a solid adhesive tape.

The present invention does not depend on making SEBS compatible with TPU or making SEBS more polar.

The present invention was developed for adhesives and low activation temperature, i.e., for a low-activation temp elastic adhesive film.

The present invention is a non-reacted, homogeneous polymer blend.

The present invention does not require a novel polymerization step, but uses traditional compounding of standard SEBS and TPU polymers to make the blend.

The present invention does not require transparency as interlayer for glass, or ability to bond to glass substrates; the present invention is opaque.

The present invention depends on SEBS as the major component and TPU as minor additive, for making a solid film.

The present invention depends on a solid thermoplastic SEBS elastic primary phase modified with TPU.

The present invention creates a solid thermoplastic SEBS elastic film, or tape, that utilizes TPU to modify surface activation temperature for adhering to curved and three-dimensional stretch fabrics in process, while performing as a solid, elastic waist (or strap) band in end application.

The present invention creates a solid highly-resilient elastic film, which can be cut to strips—or “tape”—for surface heat bonding, in continuous low-temp textile assembly processes to fabrics. The tape bonds stretch fabrics together, or attaches to one side of a fabric, while at the same time becoming a solid, more comfortable and resilient elastic band for holding apparel (e.g., underwear, bras, sportswear, etc.) on the human anatomy.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other aspects will now be described in detail with reference to the accompanying drawings, wherein:

FIG. 1 illustrates an exemplary automatic continuous bonding system.

FIG. 2 is a table.

### DETAILED DESCRIPTION OF THE INVENTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

Disclosed herein are various embodiments of materials including styrene-ethylene-butylene-styrene (SEBS)/thermoplastic polyurethane (TPU) blends. In some embodiments, the blend enhances adhesive properties of a styrene-ethylene-butylene-styrene (SEBS) block copolymer. SEBS does not have functional groups (e.g., —OH, —COOH, —OCOOR) that typically impart some “polarity” on the material. Adding functional groups on the SEBS block copolymer can increase its surface energy to improve “wettability” onto substrates and increase a chance of creating chemical bonds. The disclosed blends may be used in a variety of applications such as garments and clothing, to name a few.

In one embodiment, the blend includes adding an aromatic polyester polyurethane by melt mixing to SEBS. For example, adding up to about 10% of an aromatic polyester polyurethane by melt mixing during cast extrusion improves the “wet out” of the hot melt adhesive on the substrate to bond and develop strong chemical bonds.

In one embodiment, using higher loadings of the TPU (e.g., greater than about 20%) dramatically affected other unique and intrinsic properties of the SEBS adhesive, including, stretching and its subsequent recovery, to name a few.

Disclosed herein are various embodiments of materials including styrene-ethylene-butylene-styrene (SEBS)/thermoplastic polyurethane (TPU) blends supported with polyethylene terephthalate (PET), polyester or paper carriers, to name a few. In one embodiment, the SEBS/TPU blend may be supported on polar substrates. In another embodiment, the blend includes mostly SEBS with a bit of TPU. In other words, the portion of SEBS is greater than the portion of TPU in the blend.

In one embodiment, the blend includes adding an aromatic polyester polyurethane by melt mixing to the SEBS block copolymer. In some embodiments, adding up to about 10% of an aromatic polyester polyurethane by melt mixing during a cast extrusion process. In other embodiments, adding up to about 1%, or up to about 2%, or up to about 5% of an aromatic polyester polyurethane to the SEBS block copolymer by melt mixing during cast extrusion processes. In these embodiments, the addition of aromatic polyester polyurethane can improve the “wet out” of the hot melt adhesive on the substrate to bond and develop strong chemical bonds.

In one embodiment, the blend includes a higher loading of thermoplastic polyurethane (TPU). For example, greater than about 20%. The higher TPU loading can affect the intrinsic adhesive properties of the SEBS block copolymer and consequently the blend. In some instances, the amount of TPU may affect the stretchability and the corresponding recoverability of the SEBS/TPU blend.

In some embodiments, the SEBS/TPU blend may include less than about 20% of TPU loading, or less than about 10% of TPU loading, or less than about 5% of TPU loading, or less than about 2% of TPU loading, or less than about 1% of TPU loading.

In another embodiment, the wettability of the SEBS onto an application substrate may be improved due to the increased surface energy. A small amount of TPU within the SEBS/TPU blend may not compromise the functionalities of the blend.

In some embodiments, the SEBS/TPU blend may be applied onto a garment using a continuous bonding process. Presence of SEBS in the adhesive enhances properties such as weatherability, stretchability and recovery, to name a few. In other embodiments, the SEBS/TPU blend may include polar functional groups, including without limitation, —OH, —COOH, —NH2. The addition of these polar functional groups may further improve the wettability of the adhesive material to the substrate.

In one embodiment, TPU (e.g., up to 20%) could be added to the blend to enhance other properties, including without limitation, stretchability and recovery of the SEBS/TPU blend, when used as an adhesive for continuous bonding processes.

In one embodiment, the blend may reduce glue line temperature (e.g., activation temperature for the adhesive) of the SEBS with the addition of the TPU during the continuous bonding process.

In some embodiments, the blend may be processed with conventional equipment such as extrusion or injection molding. In some embodiments, the blend can be cast extruded into a thin film roll with suitable thicknesses. In other embodiments, the blend can be cast extruded into sheet form and die-cut to any geometric shapes or sizes in a variety of thicknesses.

Presently disclosed embodiments may be used in a variety of applications, including onto garments or clothing, to name a few. In some embodiments, the disclosed SEBS/TPU blend may improve surface energy, wettability, transparency, elasticity and stretchability, among other enhancements. In other embodiments, the blend can reduce glue line temperature (e.g., activation temperature of the adhesive) of the SEBS for continuous bonding operation.

Disclosed herein are SEBS/TPU (styrene-ethylene-butadiene-styrene/thermoplastic polyurethane) thermoplastic elastomer blends for the apparel industry as a continuous bonding adhesive tape.

Heat sealing tape has proven useful for replacing traditional thread seaming in applications such as yoga apparel, swimwear, bodywear, outdoor garments, and intimate apparel, to name a few. Heat-sealing tapes can develop a strong bond onto a garment and replace traditional stitching while providing excellent seam performance with high stretch and recovery. Heat-sealing tape can be cast extruded into the required thickness and slit into the required width and may or may not be accompanied by a release liner made of PET, paper, coated paper, or others.

Some garments can be completely or partially assembled using a heat-sealing process known as continuous bonding. In continuous bonding operations, the edge of the fabric can be simultaneously cut or trimmed, while the adhesive is applied and cooled.

Continuous bonding machines provide labor reduction costs and speed up the process of creating a seamless garment. Sew free seaming can use elastomeric adhesive tapes such as polyurethane, PEBA (polyether block amide) and styrene block copolymers that can be activated through heat and pressure and bonded into the fabric.

There are a wide variety of continuous bonding machines being used in the apparel market. The most common design includes two silicone wheels which have an adjustable speed and pressure, as well as an independent temperature control of temperature by hot air. A set of heated nozzles can blow hot air directly onto the tape and soften or melt the tape by convection.

The heated air coming from the air nozzles transfers the heat through the surface area of the elastic adhesive film. The adhesive tape is automatically fed into the continuous bonding unit and laid onto the fabric with a side-edge trimmer or folded over for a hemming and binding.

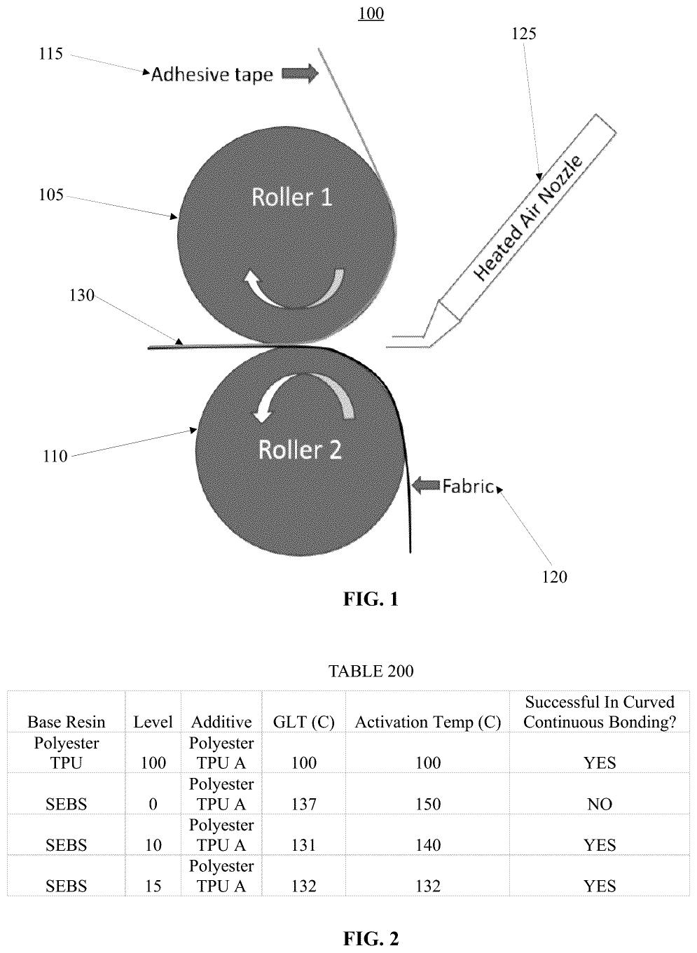

FIG. 1 illustrates an exemplary automatic continuous bonding system 100 that includes two wheels (rollers) 105, 110 that are able to control the speed and tension of an adhesive operation, where one of the rollers 105 can be used to handle an adhesive tape 115 while another roller 110 can be used to handle a material such as fabric 120. The rollers 105, 110 can be turned clockwise and counterclockwise, respectively, along with a heated air nozzle 125, to produce a resulting continuous bonded product 130. Using the wheels 105, 110, the speed and tension of the adhesive operation can be controlled. In some instances, the resulting product 130 may also be sold as slitted rolls.

Two processes are required to apply the adhesive tape 115: first a lay down operation in which the adhesive has some initial tack to the fabric 120 to bond and a second operation which can be over a hem for leg openings or other. The laydown operation typically occurs on a continuous bonding machine and the second operation can either occur on continuous bonding or heated flat press or others.

The selection of the appropriate adhesive tape 115 to be used in continuous bonding is critical. The adhesive tape 115 needs to have an adequate glue line temperature (GLT) to soften, or melt using the heated air and achieve a decent bond to the fabric 120 within a short time while being released itself from the paper or PET carrier. The line can run at speeds ranging from about 1 meter per minute to about 4 meter per minute. In a manufacturing garment plant where speeds and high yields are critical, the speed input becomes crucial.

The heated air coming off the air nozzle 125 is usually not enough to soften/melt the SEBS block copolymer. Material blend embodiments of the present invention have improved adhesive properties that can enhance their uses in continuous bonding processes.

In one embodiment, the material blend includes styrene-ethylene-butylene-styrene (SEBS) block copolymer blended with an aromatic polyester polyurethane adhesive (ranging from about 5% by weight to about 10% by weight). In this embodiment, TPU adhesives can be added by melt mixing during cast extrusion process.

In some embodiments, the primary polymer consists of a soft rubber-feel-like styrene block copolymer with a hardness range of between about 25 Shore A and about 50 Shore A, and a melting range of between about 150° C. and about 170° C.

In one embodiment, the adhesive blend includes a plasticizer-free aromatic polyester-based polyurethane hotmelt adhesive grade with a hardness range of between about 50 Shore A and about 70 Shore A, and a melting range of between about 100° C. and about 130° C. In some embodiments, the weight percentage of the adhesive blend in the primary polymer may be in the range of from about 5% by weight to about 10% by weight. In other embodiments, the material blend may exhibit the following mechanical properties: elongation at break ranging from about 600% to about 900%, tensile strength ranging from about 6 to about 9 MPa, specific gravity of the SEBS in the range of from about 0.8 to about 0.9 g/cc, and specific gravity of the blend of about 0.9 g/cc.

In some embodiments, the material blend may include SEBS block copolymer blended with a polyurethane including a crystalline TPU. In other embodiments, using higher loadings of the TPU (equal to or greater than about 10%) may affect intrinsic properties of the SEBS adhesive, e.g., stretchability and its subsequent recovery.

In some embodiments, advantages of the disclosed embodiments include without limitation: low glue line temperature (GLT) high stretch tape that can be applied using continuous bonding for curved areas with machines that work only with heated air coming from a nozzle.

Accordingly, a wider range of applications in which the blend material can be considered include manufacturing of three-dimensional (3D) cups, seams with curves such as leg openings, among others.

Additionally, the disclosed embodiments can offer flexibility on customizing existing SEBS tapes improving bonding onto a wider variety of fabrics.

In FIG. 2, Table 200 summarizes the results of curved continuous bonding processes with the various combinations of resins and additives as disclosed herein.

In summary, the present invention is a new bonding material that includes a blend of SEBS and TPU. Current technology uses TPU based material that is applied onto a garment using a continuous bonding process. Presence of SEBS in the adhesive enhances properties such as weatherability, stretchability, and recovery. Adding polar functional groups such as OH, COOH, NH2, and forth, can improve wettability of the adhesive material to the substrate. Presence of TPU (up to 20%) can enhance other properties, such as recovery and stretchability of the SEBS/TPU blend.

One goal is to reduce a Glue line Temperature (activation temperature for the adhesive) of the SEBS with the addition of the TPU. The blend may increase the wettability of the SEBS onto the substrate thanks to the increase on surface energy, while small amounts of TPU do not compromise functionality of the SEBS.

Although only a few embodiments have been disclosed in detail above, other modifications are possible. All such modifications are intended to be encompassed within the following claims.

What is claimed is:

1. An adhesive material composition comprising:
a styrene-ethylene-butylene-styrene (SEBS) block copolymer blended with 5% to 20% by weight of an aromatic polyester thermoplastic polyurethane (TPU).

2. The adhesive material composition of claim 1 wherein the styrene-ethylene-butylene-styrene block copolymer comprises:
a hardness range between 25 Shore A and 50 Shore A; and
a melting range between 150° C. and 170° C.

3. The adhesive material composition of claim 1 further comprising a plasticizer-free aromatic polyester-based polyurethane hotmelt adhesive grade with a hardness range of 50 Shore A to 70 Shore A.

4. The adhesive material composition of claim 1 wherein the plasticizer-free aromatic polyester-based polyurethane hotmelt adhesive grade has a melting range of 100° C. to 130° C.

5. An automatic continuous bonding system comprising:
a first roller for controlling a speed and a tension of an adhesive tape, the adhesive tape comprising a styrene-ethylene-butylene-styrene (SEBS) block copolymer blended with 5% to 20% by weight of an aromatic polyester thermoplastic polyurethane (TPU);
a second roller for a speed and a tension of a fabric; and
a heated air nozzle, the heated air nozzle generating heated air to melt the adhesive tape to the fabric passing between the first and second rollers.

6. The automatic continuous bonding system of claim 5 wherein the styrene-ethylene-butylene-styrene block copolymer comprises:
a hardness range between 25 Shore A and 50 Shore A; and
a melting range between 150° C. and 170° C.

7. The automatic continuous bonding system of claim 5 wherein the adhesive tape further comprises a plasticizer-free aromatic polyester-based polyurethane hotmelt adhesive grade with a hardness range of 50 Shore A to 70 Shore A.

8. The automatic continuous bonding system of claim 7 wherein the plasticizer-free aromatic polyester-based polyurethane hotmelt adhesive grade has a melting range of 100° C. to 130° C.

9. The automatic continuous bonding system of claim 1 wherein the plasticizer-free aromatic polyester-based polyurethane hotmelt adhesive grade allows continuous bonding of three-dimensional geometries and seams with curves.

10. The automatic continuous bonding system of claim 9, in which an adhesive blend grade, comprising of plasticizer-free aromatic polyester-based polyurethane and styrene-ethylene-styrene block copolymer, allows continuous bonding of three-dimensional geometries and seams with curves.

11. The automatic continuous bonding system of claim 9 wherein the plasticizer-free aromatic polyester-based polyurethane hotmelt adhesive grade creates continuous bonding at glue line temperatures below 137° C., and activation temperatures below 150° C.

12. An adhesive material composition comprising:
a styrene-ethylene-butylene-styrene (SEBS) block copolymer blended with 5% to 20% by weight of an aromatic polyether thermoplastic urethane.

13. The adhesive material composition of claim 12 wherein the styrene-ethylene-butylene-styrene block copolymer comprises:
a hardness range between 25 Shore A and 50 Shore A; and
a melting range between 150° C. and 170° C.

14. An automatic continuous bonding system comprising:
a first roller for controlling a speed and a tension of an adhesive tape, the adhesive tape comprising a styrene-ethylene-butylene-styrene (SEBS) block copolymer blended with 5% to 20% by weight of an aromatic polyether thermoplastic polyurethane;
a second roller for a speed and a tension of a fabric; and
a heated air nozzle, the heated air nozzle generating heated air to melt the adhesive tape to the fabric passing between the first and second rollers.

15. The automatic continuous bonding system of claim 14 wherein the styrene-ethylene-butylene-styrene block copolymer comprises:
a hardness range between 25 Shore A and 50 Shore A; and
a melting range between 150° C. and 170° C.
